(19) United States
(12) Patent Application Publication
(10) Pub. No.: US 2010/0324923 A1
(43) Pub. Date: Dec. 23, 2010

(54) Method and System for Converting Credit Card Rewards Points to Dollars for Medical, Dental, and Pharmacy Expenses

(76) Inventor: Melanie Ford Wilson, (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/488,332

(22) Filed: Jun. 19, 2009

(51) Int. Cl. G06Q 30/00; G06Q 50/00; G06Q 40/00

(52) U.S. Cl. 705/2; 705/14.33

(57) ABSTRACT

A method for helping a purchaser of goods pay for health care services when the purchaser uses a credit/debit card that enables participation in such a monetary reward program. A credit/debit card reader, at the point of sale, reads the information recorded on the card. The information is sent to a processor of the issuer of the credit/debit card and a data bank is accessed to determine if the purchaser is qualified to receive points based on the dollar amount of the purchase where these points are to be used to pay a portion of a health care provider's bill for services when such an expense is generated by the credit/debit card user. Each qualifying dollar amount spent on the card is assigned a predetermined number of points which can be used to pay a health care provider for a health care service provided to the credit/debit card holder.

### BACKGROUND OF THE INVENTION

1. Field of the Invention

This invention relates to a bank system for using credit cards for making purchases and more particularly to a redemption system for credit card holders to accumulate a value when purchasing goods or services where the redemption option is a reward which is used to pay health care expenses.

2. Description of the Related Art

At the present time, several banks issue credit cards where the user benefits in some manner every time a transaction using the card is made. The user benefit may be in the form of air flight miles, reward points toward purchasing a vacation, a gift, etc,

It is understood that one credit card, the Discover card, offers a Cash back Bonus service whereby the consumer receives a check at the end of a given year for an amount which varies depending on the purchases made during the year using the card.

Another credit card, the Principal Bank VISA card, offers a cash back rewards program whereby the consumer's cash back “reward” may be applied toward one of the following products: contributions to a Principal mutual fund; principal payment on a Principal consumer loan; principal payment on a Principal mortgage loan; deposit in a Principal bank deposit account such as a certificate of deposit, savings account, or money market account; contribution to a Principal variable annuity contract; or contribution to a Principal variable life contract. The reward can be selected by the consumer in an application for the VISA card. This program pays the reward each time the amount of unpaid reward reaches a threshold, such as $100.

Thus, cash benefits or reward points are provided by banks or organizations that issue the credit/debit card as an incentive for the purchaser to use their card. The credit/debit card holder has to stay within the boundaries as outlined by the card issuer or else lose the benefit.

At the present time there is a relationship between Americans loosing their access to employer-sponsored health insurance and people deferring health care because of the out of pocket costs that are involved. Additionally, a multitude of other reasons exists causing individuals not to be able to afford, obtain or maintain health insurance, such as, rising health care costs, preexisting conditions, lost employment and/or loss of employment benefits.

A recent article about health care reported that twenty percent of Americans said that cost is the primary reason they have cancelled or postponed medical care.

Considering that cost is the primary reason that individuals are not receiving the medical care that they need, it would be helpful if the various banks, companies or organizations that issue credit/debit cards would create a program to convert credit card reward points into medical spending dollars and implement a medical redemption system. The reward points would be used to pay for health care services that are provided to the card user. The credit/debit card user would be able to choose from a network of physicians, dentists, pharmacies and possibly insurance carriers and use the reward points to pay for health care services provided by a health care provider.

At the present time there is no known credit card that converts credit reward points into medical dollars to pay health care providers for health care services that are provided to the card holder.

Considering the current need to pay for needed health care of all kinds, it would be new and useful if such a program would be implemented for the user of a credit card.

The system could generate much pride and self-satisfaction in the bank or company that issues the credit/debit card knowing that they are helping their customers to pay for health care.

It is therefore a prime objective of this invention to provide a system that enables a credit/debit card holder to redeem credit card rewards points at a participating health care provider.

Another objective is to provide a system which can help relieve the concerns generated in an individual card holder knowing that he/she can now afford to see a health care provider for needed help.

### SUMMARY OF THE INVENTION

A method for helping a purchaser of goods pay for health care services where the purchaser uses a credit/debit card having user information recorded thereon to purchase goods. A credit/debit card reader at the point of sale reads the information recorded on the card. The information is sent to a processor of the issuer of the card and a data bank is accessed to determine if the purchaser is qualified to receive points for the dollar amount of the purchase where the points are to be used to pay health care provider bills for services provided to the purchaser. A dollar amount is assigned to a predetermined number of points which is used to pay a health care provider for a health care service provided to the purchaser if said health care provider has agreed to accept the dollars which are redeemed from points generated by use of the user's card for payment.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings.

FIG. 1 is a flow chart illustrating the credit/debit card reward system for health care in accordance with the principals of the invention.

### DETAILED DESCRIPTION OF THE INVENTION

This invention relates to a credit card provider allocating points that are equal to a credit card user's billing, in dollars to pay a bill for health care services performed by a health care provider from a network of providers.

By paying at least in part a person's medical bill where the amount available for payment is determined by the card holder's billing, the person will be more willing and able to access medical care that is currently being fully neglected or delayed because of financial constraints. There are a number of instances where delayed treatment of an advancing medical condition can result in a more serious and possibly an untreatable condition. In these instances it can be said that treatment delayed is tantamount to treatment denied.

In practice, while the credit card issuer is helping a person who needs their help, they are also helping a person who deserves their help because that person, by buying goods using the card, is instrumental in helping the credit card issuer increase their profit margins.

Using the system of this invention, the credit card issuer can benefit by helping to keep their loyal customers in better health and by knowing that they are helping to diminish a national health care problem that we all face.

The method and system that is here disclosed will benefit the card users by providing them with medical care without delay and with no financial outlay (sufficient credit to cover the entire medical costs) or at a reduced out-of-pocket expense (when partial credit is used toward the medical cost). Medical providers will benefit by increasing their patient volumes. Credit card issuers will benefit by maintaining and increasing their subscriber base, credit card usage, recovery of interest and fees, as well as the percentage paid by the merchant.

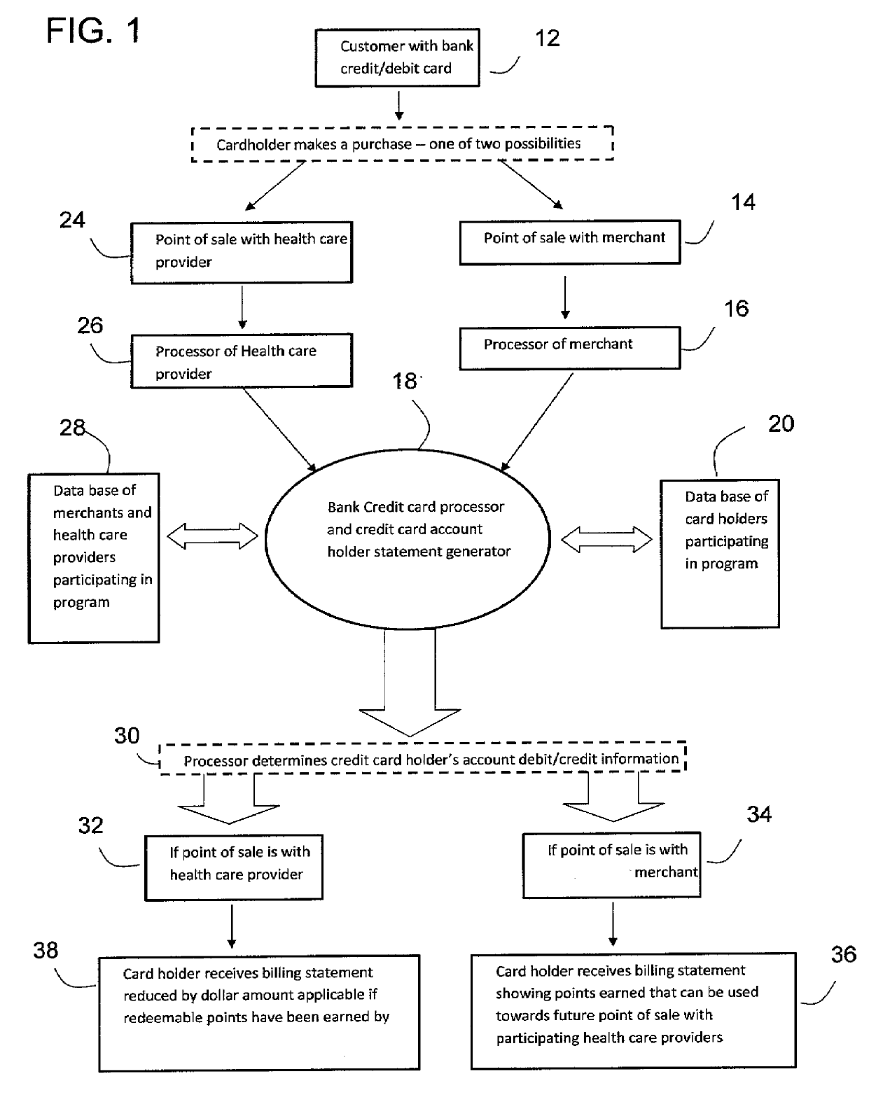

Referring to FIG. 1, there is shown a flow chart that illustrates the reward system to pay a health care provider's bill where the card holder's billing determines the amount of points that are received and which can be redeemed for money that is available to pay the health care provider's bill.

The present invention pertains generally to a method which allows a consumer to easily and incrementally obtain money in the form of points to pay a health care provider

With the invention, incremental accrual of points which translate into dollars can be accumulated. This may be accomplished in various ways. For instance, the consumer may have an agreement with the credit card issuer whereby, as a result of the transaction, the consumer's credit card bill reflects not only the merchandise charge but also an incremental point accumulation. When the credit card bill is paid by the consumer, the card issuer will automatically allocate the incremental savings deposit portion to the consumer's account for payment of his/her health care bills.

Referring to FIG. 1, at the start, a card user selects an item for purchase at a store and presents his/her credit/debit card, block 12, to the merchant's cashier to pay for the item. The cashier swipes the purchaser's card at the point of sale terminal, block 14. From the point of sale, when the transaction is made, information which includes the amount of the sale, the identity of the merchant, the identity of the purchaser, the date and time of the transaction, in addition to other information recorded in the processor of the merchant in electronic form, block 16, is transmitted to the bank credit card processor, block 18.

The bank processor 18 queries a data base, block 20, which identifies the purchaser as being one of a group of persons entitled to receive points for the total amount of the purchase price. The bank processor 18 transfers the designated amount of points to the purchaser's account, located in block 18, where the points are stored for use in paying for health care services when needed by the purchaser.

Health care service can be defined as a service that is provided by any Medical Doctor, Dentist, Pharmacist, etc., as initially identified by the credit card issuer as having agreed with the card issuer to accept money redeemed from points to pay for health care service. In the preferred embodiment, the costs associated with this system/method are negotiated with the health care service providers. In an alternate embodiment, the cost for providing this service may also be negotiated with a merchant from where purchases were made, or by paying a small amount to the organization from the card user.

In an embodiment, money from the card issuer for points generated by the card user can be used to pay premiums that are charged by an insurance carrier where the insurance carrier may agree to charge a reduced premium.

At some instance the card user may visit a health care provider for an examination, a required procedure, etc., and the health care provider will generate an invoice. An employee at said health care provider's office swipes the card, block 24, and submits the invoice and patient information to the processor of the health care provider, block 26. This information is then transmitted to the bank credit card processor, block 18.

The bank credit card processor queries data base, block 28, which has the ability to either identify a merchant or health care provider as a participant in said program.

Returning to where the purchaser has recently received points which were entered into his/her account in the bank credit card processor 18, the processor determines, in block 30, if the point of sale is at a health care provider, block 32, or if the point of sale is at a merchant, block 34. In this example, the point of sale is at a merchant, therefore the process advances from block 34 to block 36 where the card holder receives a billing statement showing points earned that can be used towards future point of sale with health care providers.

Referring now to where the bank credit card processor 18 identified the point of sale as being from a health care provider, the process advances through block 30, and block 32 to block 38 where the card holder receives a billing statement that is reduced by a dollar amount applicable if redeemable points have been earned by the cardholder.

With this system, the card issuer will clearly have an increased number of subscribers with greater card usage because of the health care costs benefits that it will provide to its card users.

A major advantage of the method disclosed is that it provides a stimulus for credit card issuers and merchants to help a person who has been instrumental in helping them increase their bottom line to pay his/her medical bills. While it is not a charitable endeavor, it will clearly help people who are in need of financial help and, clearly, will help America and a deserving group of Americans.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A method for helping a purchaser of goods pay for health care services comprising the steps of:
providing a credit/debit card having user information recorded thereon;
reading the information on the credit/debit card via a point-of-sale reader;
sending said information to a processor of the issuer of the credit/debit card where a point amount to a purchase being made by said purchaser of goods to said information is assigned; and
accessing a data bank to determine if the purchaser is qualified to receive points for the dollar amount where said points are redeemed for dollars which are used to pay health care provider bills for services provided to the purchaser.

2. The method of claim 1 further comprises the step of:
paying a dollar amount to a health care provider for a health care service received by the purchaser if said health care provider is a member.

3. The method of claim 2 wherein the health care provider is paid for a service performed for the purchaser by entering the purchaser's card and amount due

4. The method of claim 3 wherein the health care provider is paid with dollars redeemed from points stored in the credit card issuer's system.

5. The method of claim 4 wherein the points used to redeem dollars are points assigned to the purchaser.

6. The method of claim 5 wherein the health care provider receives payment for the service rendered to the purchaser only if the purchaser has accumulated points toward the cost when the points are redeemed for dollars.

7. The method of claim 6 wherein said health care provider is not qualified to provide points to a purchaser of health care service.

8. The method of claim 6 wherein said health care provider is qualified to provide points to a purchaser of health care service.

9. The method of claim 5 wherein a purchaser of health care service from a participating health care provider receives a billing statement that is reduced by a dollar amount applicable if redeemable points are available to the purchaser.

10. The method of claim 5 wherein a purchaser of goods from a merchant receives a billing statement showing points earned that can be used towards future point of sale with health care providers.

11. The method of claim 5 wherein said health care provider is a Medical Doctor.

12. The method of claim 5 wherein said health care provider is a Dentist.

13. The method of claim 5 wherein said health care provider is a Pharmacist.

14. The method of claim 5 wherein said health care provider is a licensed health care provider.

15. The method of claim 5 wherein the purchaser and the health care provider must be members in the program for the health care provider and the purchaser to be benefices.
